(19) United States
(12) Patent Application Publication
(10) Pub. No.: US 2011/0011006 A1
(43) Pub. Date: Jan. 20, 2011

(54) METHOD FOR THE PRODUCTION OF AN INSULATED WINDOW OR DOOR FRAME

(75) Inventors: Manfred Wuest, Ettringen (DE); Andreas Heilig, Graben-Neudorf (DE)

Correspondence Address: VOLPE AND KOENIG, P.C., UNITED PLAZA, 30 SOUTH 17TH STREET, PHILADELPHIA, PA, 19103, US

(73) Assignee: ALUPLAST GMBH, Karlsruhe (DE)

(21) Appl. No.: 12/837,539

(22) Filed: Jul. 16, 2010

Related U.S. Application Data
(60) Provisional application No. 61/226,045, filed on Jul. 16, 2009.

(51) Int. Cl. E06B 3/00

(52) U.S. Cl. 49/506

(57) ABSTRACT

A method for producing a frame as a window or door frame that is made from hollow-profile elements and that has a chamber that contains an insulating foam core, wherein the frame is assembled from several hollow-profile elements. In order to insulate such a frame in an economical way, the insulating foam core is generated first after joining the frame through filling the chambers that are provided in the hollow-profile elements and that communicate with each other with foam.

### CROSS-REFERENCE TO RELATED APPLICATIONS

This application claims the benefit of U.S. Provisional Application 61/226,045, filed Jul. 16, 2009, which is incorporated herein by reference as if fully set forth.

The invention relates to a method for the production of a window or door frame made from hollow-profile elements with at least one chamber that is continuous in the longitudinal direction and that contains an insulating foam core, wherein the frame is assembled from several hollow-profile elements.

Frames of the type relevant here are used in window construction as the window frame or as a casement frame. In a known way, the hollow-profile elements are formed of aluminum or else advantageously plastic, such as, PVC. The hollow profiles here have, in a known way, several chambers lying adjacent to each other for sound and heat insulation.

For plastic profiles it is known, on one side, to insert metal rails that are made, in particular, from steel, into individual chambers for stabilizing the frame and that are, in a known way, in the shape of a square tube or simple, open roll profiles.

In order to reduce the heat transfer through such frames, it is further known to fill at least individual chambers with an insulating foam core. For this purpose, either a prefabricated foam core is inserted that is combined optionally with one of the mentioned metal rails or a foaming material is injected into the hollow profile.

The production of the hollow-profile elements is typically performed in several stages. In the first stage, a corresponding hollow profile is produced in a length of several meters in a factory. In the second stage, a hollow-profile element with the required dimensions is cut from this several-meter-long material in the factory of a window maker. Such a hollow-profile element is then typically provided at its ends with a miter and assembled there while forming an angle of, for example, 90° with another hollow-profile element.

For this assembly, the cut edges of the hollow-profile elements are brought together with a heating blade there-between. They are heated by the heating blade and finally pressed together after removal of the heating blade. After cooling the pressed-together cut edges, a tight corner joint is produced.

The hollow profiles known up to now with an insulating foam core, however, lead to problems with this processing: while the material of the hollow-profile elements becomes somewhat shorter in the described joining/welding, the foam core that frequently consists of a duromer maintains its original length. The corresponding insulating foam cores thus must be shorter at the beginning or must be made shorter accordingly before joining two hollow-profile elements, in that the foam core located in the hollow-profile element is milled at the interface or removed by hand.

Both measures are disruptive to the work process, because it is difficult to shorten the foam core precisely by the exactly required amount. If the foam core is not shortened sufficiently, this can lead to problems when two hollow-profile elements are joined. If the foam core is shortened too much, the final frame has, at the point joining two hollow-profile elements, an undesired cold bridge that is not tolerable for today's requirements.

### SUMMARY

The objective of the invention is therefore to provide a method for producing a frame made from hollow-profile elements, in particular, made from plastic, and the door and window construction, wherein the frame contains an insulating foam core and is assembled from several hollow-profile elements, and this frame is distinguished by a simple work process and guarantees a seamless progression of the insulating foam core at the points joining two hollow-profile elements. This method should also be able to be performed reliably in the factory of a window maker and should also be economical with respect to the general cost pressure dominating the construction business.

This objective is met according to the invention in that first the hollow-profile elements are connected to form a frame and then the insulating foam in fluid form is filled into the at least one chamber through at least one opening of the frame, wherein the mentioned opening and/or at least one additional opening of the frame permits air displaced by the expanding insulating foam to escape from the chamber.

The advantage of the invention lies in that, through the subsequent foam expansion, the insulating foam virtually automatically flows through the chambers arranged one after the other in the peripheral direction and continuously fills up past the corners of the frame. Difficult shortening of a prefabricated or subsequently injected insulating foam core is eliminated. Furthermore, window makers are accustomed to working with foams, because mounting foam is often placed around window frames during their installation. Not the least of which, it is also favorable that the foam expansion in the entire frame takes place in one processing step, which saves additional handling costs.

In principle, the foam expansion can be realized using arbitrary foams, although multi-component foams are preferred, in particular, polyurethane foams.

The individual components of the foam can be introduced into the provided chambers via separate dosing pumps, advantageously simultaneously, so that the mixing of these components takes place, in particular, at the time they are introduced into the chambers to be filled with foam. Through a corresponding reaction delay it can be ensured that the expanding foam begins to harden only when the component mixture has been distributed to all of the chambers to be filled with foam, so that a complete and uniform foam expansion is guaranteed.

As far as the introduction of foam or its components is discussed above and below, the introduction of the foam in any way is intended, that is, both the introduction of a single component foam in a not-yet foaming state, at the beginning of foaming, or for delayed foaming, just like the introduction of the foam components in a not-yet mixed state, in an already mixed state, in a not-yet foaming state, or at the beginning of or for delayed foaming.

For the case of a preferred embodiment, fiber-reinforced foam can be processed. Therefore, the insulating foam core can also take on stabilizing or load-bearing functions, so that the installation of metallic reinforcement profiles is unnecessary.

In order to be able to perform the foam expansion within a typical production method for a window frame in the factory of a window maker, it is provided, in particular, to hold the frame in an essentially vertical position during the foam expansion. In this way it has proven advantageous to perform the introduction of the foam in the region of one corner of the frame, so that the foam can be inserted in fluid form at high pressure into a sufficiently large hollow space, without the flow having to be diverted.

Advantageously, the introduction of the foam into the chambers to be filled with foam takes place by means of a directed flow, optionally, simultaneously in two opposite directions. This method promotes the most uniform possible distribution of the foam across the entire frame extent.

The introduction of this directed flow can be realized here by a flexible tube that can be inserted into the chamber to be filled with foam. Through the use of a hose, the foam can be inserted with increased certainty deep in the chamber to be filled with foam. Work could also be performed with an intake opening outside of the corners, because the flow is diverted in the hose.

It is also possible to perform the introduction of the foam from above for an approximately vertical position of the frame. Due to the force of gravity, the forming foam is then distributed very well into the chambers to be filled with foam.

It has also proven advantageous to rotate the frame in the vertical plane after the introduction of the foam. This promotes the filling process and uniform expansion of the foam. For the described rotation in the vertical plane, it is achieved, in particular, that the automatic foam expansion penetrates into all regions of the frame and finally reaches the ventilation opening.

So that the forming foam does not pass outward again at the intake opening in an undesired way, the opening can be closed by a plug after the foam is inserted.

Alternatively, a valve could be installed in the intake opening, such that the fluid can flow only into the frame in the insertion direction but cannot flow outward. In addition, a small cock could alternatively be mounted in the intake opening, wherein this cock selectively allows or blocks the inward and outward flow.

At this point it should be noted that the introduction of the foam does not absolutely have to be performed through external excess pressure or through the force of gravity, but instead a low pressure could also be applied at another opening of the frame, so that the foam or its components are suctioned into the frame.

In principle, it is definitely also possible to perform the introduction of the foam for a horizontally lying or slightly inclined frame.

In order not to hinder the foam formation, it is recommended to draw air from the chambers to be filled with foam during the foam expansion by at least one opening. Advantageously, the ventilation is performed by several openings at a distance from the intake opening, so that the discharge of gas remains guaranteed even when the forming foam reaches and in this way closes one of these ventilation openings.

It has proven favorable to allow upward ventilation through openings, in order to achieve foam expansion that is uniform up to the end. Simultaneously, these openings are also used to inspect that the frame has been completely filled with foam.

For particularly large frames and thus correspondingly long extents of chambers to be filled with foam, it lies in the scope of the invention to provide a chamber to be filled with foam with at least one flow-path boundary that divides the chamber in the longitudinal direction. Such a flow-path boundary can be generated, if necessary, by inserting a plug, in particular, a foam plug or the like. It is proposed to provide this plug in a hollow-profile element before this is assembled with other elements to form a frame. In this way, two or more chambers are created that are separated from each other according to flow and that follow one after the other in the peripheral direction of the frame, but are separated from each other by the foam plug that has an equally insulating effect. In this case, the foam filling also extends past at least one corner of the frame into at least one adjacent chamber.

It also lies within the scope of the invention to eliminate the introduction of a flow-path boundary and—in particular, for very long hollow profiles—to fill the frame with the insulating foam by the use of two or more insertion openings. Preferably, the insertion openings are then distributed across the frame extent with an approximately equal spacing, so that the flow paths covered by the insulating foam in the chambers have approximately the same length and require approximately the same insertion quantities and hardening times.

However—especially for irregularly angled or for bent frames—the principle of the present invention includes consciously selecting the individually filled chambers with different lengths, wherein there is also the possibility to fill special chamber regions with other foam compositions or with a different excess pressure.

Alternatively, it is possible to fill two or more chambers that run parallel to each other with foam separately. This can significantly increase the desired insulating effect and reinforcement effect when needed.

As already discussed above, a preferred application for the method is the production of a door or window frame, that is, as a window frame or casement frame. It is proposed to arrange the openings provided for the introduction of the multi-component foam and also for the ventilation of the chambers to be filled with foam in a groove or fold running on the outside of the hollow-profile elements. Because such hollow-profile elements are provided with grooves or folds in which special coatings or glazing or other fillings are installed, the mentioned openings can be covered so that they cannot be seen for a completely built window.

It should also be mentioned that the frame is filled with foam advantageously in an unglazed state for the production of a window casement.

If a corresponding frame is to be constructed in a known way with a metal rail reinforcing this frame, it is proposed that this metal rail is perforated. In this way, the expanding insulating foam can surround and penetrate the rail without forming bubbles or the like and thus a uniform insulation can be achieved across the entire length with a simultaneous intimate contact between the insulating foam core and the metal rail.

### BRIEF DESCRIPTION OF THE DRAWINGS

Additional advantages and features of the invention are given from the following description of an embodiment and from the drawing. Shown are:

FIG. 1 is block diagram of a frame to be filled with foam in a first position,

FIG. 2 is a block diagram of a frame to be filled with foam according to FIG. 1 in a second position,

FIG. 3 is a cross-sectional view through a hollow-profile element with an expanded insulating foam core, and

FIG. 4 is a cross-sectional view through a hollow-profile element with an expanded insulating foam core and a reinforcement profile enclosed by this core.

### DETAILED DESCRIPTION OF THE PREFERRED EMBODIMENTS

FIG. 1 shows a frame 1 that is assembled from several hollow-profile elements 2-5. The individual hollow-profile elements are here welded at their ends which have been provided with corresponding miter cuts 6.

The hollow-profile elements are advantageously made from a plastic, such as, for example, PVC and have, in their interior, at least one continuous chamber 7 parallel to their longitudinal extent.

For the assembly of two hollow-profile elements cut with miters, they are held laterally on a heating blade with their angled cut edges and heated in the region of these cut edges. After removing the heating blade, the cut edges are then pressed against each other, wherein they are connected tightly to each other and wherein the corresponding chambers 7 are also connected to each other in the adjacent hollow-profile elements.

In the example shown here, in the end an essentially rectangular frame is obtained in which, through the corresponding chambers 7, an inner, closed channel is formed. Apart from straight hollow-profile elements, however, it is also possible to use bent hollow-profile elements, for example, for an arc-shaped window.

The shown frame is moved into a vertical position and is provided in the region of a corner then lying at the top with a borehole 8 that opens into the chamber 7.

It can be seen that the borehole 8 is formed in the hollow-profile element 3 in the region of the axial extent of the hollow-profile element 4, wherein it is approximately aligned in its axial extent with the center axis of the chamber 7 running downward within the hollow-profile element 4. Instead, the foam could also be formed approximately in the center above one of the hollow-profile elements, for example, in a region visible for the end user, when the borehole is closed with a decorative plug.

One or more foam-forming and then hardening component(s) in a predetermined quantity in fluid form are inserted into the chamber 7 through the borehole 8, in particular, by a flexible hose. For several foam components, they are first mixed when inserted into the chamber 7 or shortly before. It is essential that the chemical or physical reaction leading to the desired foam expansion and subsequent hardening is performed only after a certain time delay. In this time, the components flow in a directed flow through the chamber 7 in the hollow-profile element 4 downward into the chamber of the hollow-profile element 5 and possibly also into the chambers of subsequent hollow-profile elements.

The multi-component foam that is inserted involves, for example, a PU foam that could also be mixed with glass or carbon fibers that lead to a fiber reinforcement of the formed insulating foam core during the foam expansion.

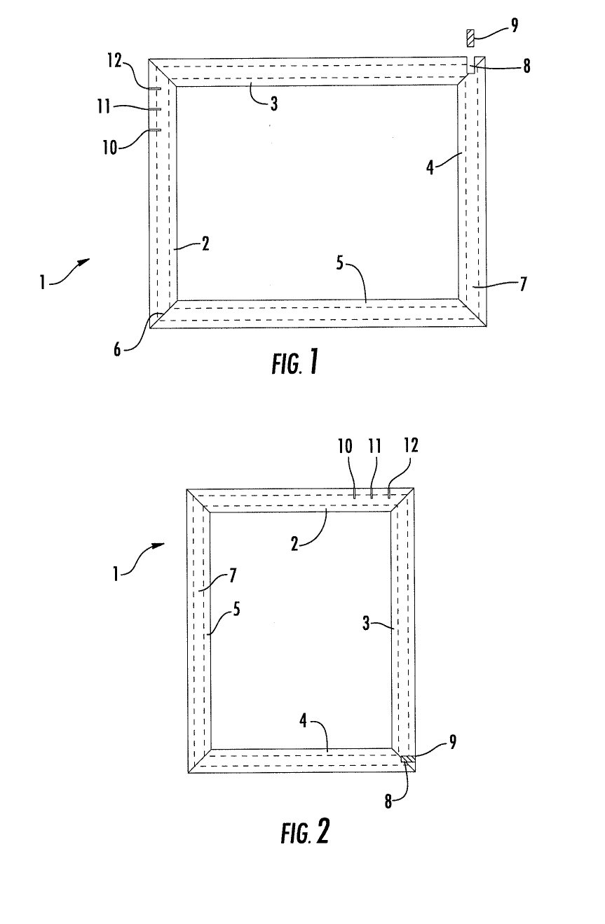

After a predetermined quantity of foam component(s) have been introduced into the chamber 7, the borehole 8 is closed with a plug 9. The frame 1 is then rotated in its vertical plane by approximately 90° , as shown in FIG. 2. Thus, the corner of the frame with the opening 8 and the plug 9 located therein comes to lie in a position at the bottom. The previously horizontally aligned hollow-profile elements 3 and 5 come into a vertical alignment and the previously vertically aligned elements 2 and 4 come into a horizontal alignment. Simultaneously, three ventilation openings 10, 11, 12 that are spaced apart from each other come into a position at the top, preferably in a position that is reached last by the foam.

Alternatively, the ventilation openings could also be formed as an elongated slot that extends in the longitudinal direction of the profile elements. They can be closed by air-permeable, but liquid-impermeable material.

After the time delay discussed above, the insulating foam then develops within the chambers 7 from the inserted foam component(s), and this foam gradually expands and forms an insulating foam core filling up the entire frame.

During this foam expansion, the air located in the chambers 7 is displaced and escapes through the ventilation openings 10-12. In addition, excess foam can also escape in this way if the openings are not closed in a foam-impermeable manner. These ventilation openings can open to the outside of the profile elements—preferably in a non-visible area—but they could also open into one or more secondary chambers.

Alternatively from what is shown in FIGS. 1 and 2, it can be useful to position the ventilation opening(s) relative to one or more intake borehole(s) so that the foam components must flow in both peripheral directions of the frame along approximately equally long paths until they reach the ventilation opening(s). Here, the foam is preferably filled in two opposite directions. Also, the filling and foam expansion can be performed for approximately horizontally lying or slightly inclined frames.

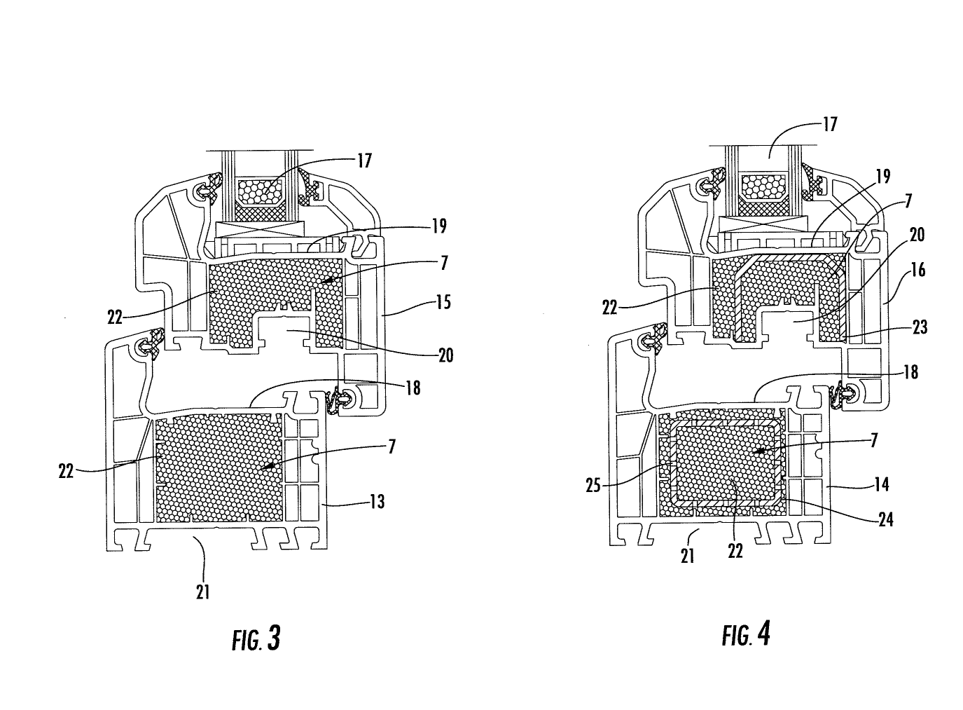

In FIGS. 3 and 4, sections through frames according to the invention are shown. These frames involve window frames 13, 14 and door or casement frames 15, 16.

In the sections, it can be seen that both the window frames 13, 14 and also the casement frames 15, 16 are provided with folds 19 and grooves 20 or with grooves 21. In these folds or grooves, the boreholes 8 or ventilation openings 10-12 discussed above end, because here they lie in regions that are not visible in the installed state of a window. Here, the coatings that are typical for a casement frame and that also cover corresponding openings are mounted in the grooves 20.

In FIGS. 3 and 4, it can be seen that the inner chambers 7 are filled by an insulating foam core 22 that expands to the exact contours of the chambers and that is formed by an expanding foam inserted into the peripheral chambers 7 as described above.

Here it can be useful to fill the fluid component(s) with an excess dose of ca. 5% to 10% generating the insulating foam, so that a certain foam compression takes place during the foam expansion and hardening.

In FIG. 4 it can be seen that metallic reinforcement profiles 23, 24 are inserted into the chambers 7, wherein these reinforcement profiles cause an additional reinforcement of the shown hollow-profile elements. The box-shaped reinforcement profile 24 shown at the bottom in FIG. 4 has numerous holes 25. The foam can pass through these holes and can then also fill up the inner space of the reinforcement profile 24 and connect this intimately to the frame.

In principle, it is possible that adjacent chambers are also filled with foam instead of or in addition to the inner chamber 7.

In summary, the invention described here represents a method for producing a window or door frame with good insulation and reinforcement across its entire extent in a quick, economical, and reliable way.

1. A method for producing a door or window frame (1) made from hollow-profile elements (2, 3, 4, 5) with at least one chamber (7) that contains an insulating foam core (22), comprising:
assembling the frame (1) from several serially connected hollow-profile elements (2, 3, 4, 5) by first connecting the hollow-profile elements (2, 3, 4, 5) to form the frame (1) and then,
inserting insulating foam (22) in fluid form into the at least one chamber (7) through at least one opening (8) in the frame, and
allowing air to escape from the chamber (7) through the at least one opening (8) and/or at least one additional opening (10, 11, 12) in the frame.

2. The method according to claim 1, further comprising:
allowing the insulating foam (22) to flow in a peripheral direction into the chamber (7) across an entire extent of the frame (1) including ones of the serially connected hollow-profile elements (2, 3, 4, 5) in a corner region.

3. The method according to claim 1, wherein
the chambers (7) of the serially connected hollow-profile elements (2, 3, 4, 5) are filled by the insulating foam (22) continuously to at least 75%.

4. The method according to claim 1, wherein the insulating foam comprises a multi-component expanding foam.

5. The method according to claim 1, wherein the insulating foam comprises a fiber-reinforced foam.

6. The method according to claim 1, further comprising:
positioning the frame (1) essentially vertically during the insulating foam expansion.

7. The method according to claim 1, further comprising:
introducing the insulating foam into the at least one chamber (7) using a directed flow or by two opposite directed flows.

8. The method according to claim 1, further comprising:
introducing the insulating foam from at least one of above or from one side of the frame.

9. The method according to claim 1, further comprising:
after the introduction of the insulating foam, closing the opening (8) provided for introducing the insulating foam with a plug (9).

10. The method according to claim 1, further comprising:
providing the opening (8) with at least one valve.

11. The method according to claim 1, further comprising:
using suction through the at least one additional opening (10, 11, 12) to assist with the introduction of the insulating foam.

12. The method according to claim 1, further comprising:
rotating the frame (1) approximately in a vertical plane after introduction of the insulating foam such that the opening (8) provided for the introduction comes into a position at a bottom thereof

13. The method according to claim 1, wherein at least one of the openings is a ventilation opening that is closed by an air-permeable, but fluid-impermeable material.

14. The method according to claim 1, further comprising:
ventilating the chamber (7) using at least one slot or multiple ones of the openings (10, 11, 12) set at a distance from each other and located at a top of the frame.

15. The method according to claim 1, further comprising:
providing a flow-path boundary in the chamber (7) dividing the chamber into subsequent chambers (7) in a peripheral direction.

16. The method according to claim 1, wherein at least one of the opening (8) for the introduction of the insulating foam or the at least one opening for the ventilation (10, 11, 12) of the at least one chamber (7) are arranged in a groove (20, 21) or fold (18, 19) running on an outside of the hollow-profile element.

17. The method according to claim 1, wherein the frame (1) is a casement frame (15, 16) that is filled with foam while in an unglazed state.

18. The method according to claim 1, further comprising:
introducing reinforcement profiles (24) into the at least one chamber (7) before joining of the hollow profiles (2, 3, 4, 5).

19. The method according to claim 18, wherein the reinforcement profiles are perforated.

20. A window or door frame produced according to the method of claim 1.
